(19) United States
(12) Patent Application Publication
(10) Pub. No.: US 2005/0173349 A1
(43) Pub. Date: Aug. 11, 2005

(54) Metal ion extraction materials and processes using same

(76) Inventor: William H. Jay, Victoria (AU)

Correspondence Address: BIRCH STEWART KOLASCH & BIRCH, PO BOX 747, FALLS CHURCH, VA, 22040-0747, US

(21) Appl. No.: 10/472,510

(22) PCT Filed: Mar. 21, 2002
(86) PCT No.: PCT/AU02/00325

(30) Foreign Application Priority Data
Mar. 23, 2001 (AU) PR 3936

(51) Int. Cl. C02F 1/42

(52) U.S. Cl. 210/681

(57) ABSTRACT

The invention relates to a metal ion extractant material for use in the extraction of metal ions from a solution or slurry, the extractant material being based on an ethyleneimine-containing polymer. The ethyleneimine-containing polymer may be attached to a solid substrate which may optionally be ground to form a particulate extractant material. Alternatively, an ethyleneimine-containing polymeric material may be cross-linked and subsequently ground to form a particulate metal ion extractant material without the need for a solid substrate.

### BACKGROUND TO THE INVENTION

In an effort to reduce contamination of waterways due to the presence of metal ions, their removal from effluents is now becoming mandated. Such removal should occur at the point of production of that effluent and prior to its release into the environment or into any aqueous systems which could transport these metal ions into the environment.

A variety of processes have been proposed for the removal of these contaminating metals. These known processes include, precipitation, ion flotation, electrolytic flotation, ion exchange or ion chelation using extractants in either solid or liquid form, electrodialysis and membrane processes such as reverse osmosis.

The processes presently being employed or under active consideration, all have significant limitations. For example, the neutralisation, precipitation and agglomeration process is accompanied by the problem that the metal hydroxide sludge so generated requires dewatering and fixation prior to deposition in a suitable containment. Because the minimum solubility for different metal hydroxides varies depending upon solution pH, it is difficult to remove mixtures of heavy metals to below their respective licensed discharge levels. No value is obtained for the metals removed and it is difficult to reduce the metal ion concentration in the effluent to levels required for safe discharge of the treated water. Furthermore, it is possible that depending upon the method adopted for disposal of the sludge, metal redissolution could reoccur thereby causing secondary contamination.

Liquid ion exchange polymers (generally referred to as solvent extractants) generally only provide selectivity for one metal and then only at a particular solution pH. For example, copper ions may be selectively extracted at a pH of 2.0 from iron, but at pH 3.0 significant quantities of iron will be extracted along with the copper. Furthermore, if cobalt was present in the aqueous solution, the extractant may not be able to extract it at the given solution pH.

Commercially available solid ion exchange resins generally have poorer metal ion selectivity than liquid ion exchange reagents. They also generally have much poorer loading and stripping kinetics than are exhibited by liquid ion exchange systems. Furthermore, they generally tend to be much more expensive to purchase on a kilo metal ion extracted/kilo resin basis than the equivalent liquid ion exchange reagent leading to a higher plant installation cost.

Therefore, metal ion extraction systems which are less sensitive to changes in solution pH, are selective towards nickel, copper and cobalt over other metal ions are desired, particularly for the treatment of acid mine drainage and cyanide-containing leach solutions.

Grinstead in U.S. Pat. No. 4,741,831 proposed that water soluble polyethyleneimines containing a pendant pyridine group may be used for the recovery of metal ions from aqueous solutions. Similarly, Smith et al in U.S. Pat. Nos. 5,643,456, 5,766,478 and 5,891,956 described modified water soluble polyethyleneimines and possible applications for these modified liquid polymers.

Japanese Patent Application Nos. 39358/1981 and 3549/1987, Ranier in U.S. Pat. No. 3,715,339, Moriya et al. in U.S. Pat. Nos. 5,347,071 and 5,387,365, Moore et al. in U.S. Pat. No. 4,578,195, Dingman et al. in Anal. Chem. (1974), 46, 774-777 and Talanta (1989), 36, 861-863, Hackett and Siggia Environ. Anal. (1977), Ed. G. W. Ewing, Acad. Press, Inc., New York, pp 253-265 and Miyazaki and Barnes in Anal. Chem. (1981), 53, 299-304 all propose chemical methods based upon polyethyleneimines or modified polyethyleneimines such as poly(dithiocarbamates) whereby metal ions can be immobilised and then safely discharged into landfills. None of these patents suggest that desirable metal ions can be economically recovered from the effluent to reduce the cost of the precipitation process.

One such method is described in PCT/AU00/01383. In this patent, a water-soluble polyethyleneimine or a modified polyethyleneimine is employed to complex with say the copper species to form a long-chain copper complex. This complex is recovered from the solution by membrane separation and the copper is recovered by electrolysis. The polyethyleneimine compound is then recycled.

A desirable alternative to PCT/AU00/01383 would be to fix, tether, or immobilise the polyethyleneimine or modified polyethyleneimine to a solid substrate. The solid substrate could be contacted with a copper-containing effluent solution to complex the copper allowing any iron or other metal ions present to remain uncomplexed in the effluent solution for an alternative separation treatment. In a similar manner, in the treatment of solutions containing copper cyanide and gold cyanide, the copper could complex with the polyethyleneimine and be removed from the solution and the gold cyanide separately recovered by alternative methods such as by the application of activated carbon, ion exchange resins, cementation on zinc, or other suitable methods. The copper would then be stripped from the solid polyethyleneimine compound and recovered by methods such as electrolysis.

Low molecular weight polyethylene glycol can be used to couple biological material to a solid support by using an organic diisocyanate to couple one end to the biological material and the other end to a cellulose support.

Regenerated cellulose sponge has been proposed for immobilising polyethyleneimine-based compounds. In U.S. Pat. No. 4,332,916,2-butenyl-bis[1,4-bis(2-hydroxyethyl)sulphonium chloride is used to crosslink the polyethyleneimine and attach it to the sponge material. The reaction is conducted for 15-90 minutes at 100-145° C. And, in U.S. Pat. Nos. 5,002,984, 5,064,540, 5,096,946, 5,162,404, 5,169,883, 5,187,200, 5,294,652, 5,336,704, 5,595,652 and 5,597,850 nitrilotriacetic acid is mixed with polyethyleneimine, impregnated into cellulose sponge and cured at 130-165° C. to form a polyamide-solidified sponge material. These patents suggest methods for using the sponge materials in a variety of applications including the recovery of silver and other heavy metals (U.S. Pat. Nos. 5,595,652 and 5,597,850) and the inclusion of additives such as a metal sulphide (U.S. Pat. No. 5,336,704) and metal ions (U.S. Pat. No. 5,187,200). The nitrilotriacetic acid may be replaced by malonic, succininc and glutaric acids (U.S. Pat. No. 5,169,883) and by polycarboxylic acids which preferably contain amino nitrogens and include iminodiacetic acid and EDTA (U.S. Pat. No. 5,187,200).

The coupling of ligands to solid supports through specific water soluble linkers is reported in U.S. Pat. No. 3,715,278 to Miller and to Nakashima et al. in U.S. Pat. No. 4,352,884 for the production of bio-active chromatographic agents.

A copolymer containing β-hydroxyalkylamine is disclosed in U.S. Pat. No. 4,210,722; a polyamine impregnated support in U.S. Pat. No. 4,415,663; a crosslinked polymer containing tertiary amino groups or quaternary ammonium salts in U.S. Pat. No. 4,132,596; copolymers of acrylic acid in U.S. Pat. No. 4,451,568; polyamine adsorbed on activated carbon in. U.S. Pat. No. 4,438,196; regenerated cellulose containing pendant carboxylic anhydrides in U.S. Pat. No. 4,610,962 and latex particles coated with water insoluble copolymer in U.S. Pat. No. 4,581,337.

Larsson et al. in U.S. Pat. No. 4,532,232 and Glad et al. in U.S. Pat. No. 4,406,792 disclose the coupling of a ligand to a silica support by the use of a short length linker such as glycidoxypropyltrimethoxy silane. Rosenberg in U.S. Pat. No. 5,695,882 and Rosenberg and Pang in U.S. Pat. No. 5,997,748 have demonstrated that polyethyleneimines can be tethered to a silica substrate via a silane coupling reaction and a subsequent immobilisation reaction, followed by chemical modification of the polyethyleneimine. This complex chemical process produces a high cost product in which the polyethyleneimine is closely coupled to the silica substrate. Whilst the product produced using these patents may meet some of the desired metal ion complexing features for the removal and subsequent recovery of that metal ion, the metal ion loading kinetics are slow, requiring long contact times for recovery of the metal from aqueous solutions. This is particularly evident in the slow rate of complexation of copper present in copper cyanide-containing solutions. Slow complexation kinetics leads to a requirement for larger vessels and higher concentrations of the solid extractant to provide sufficient residence time in recovery systems intended for the selective removal of copper from gold and copper cyanide-containing solutions.

It has now been discovered that to rapidly coordinate or chelate with metal ions, in tethering or immobilisation of the polyethyleneimine to the substrate sufficient spacing should exist between the polyethyleneimine or the chemically modified polyethyleneimine complex to enable the complex to have sufficient flexibility to be able to contact the metal ion.

Furthermore, the cost of the desired product can influence the use or otherwise of the tethered product in applications such as acid drainage. In certain instances, the volume of water may be very large but the actual metal content can be very low. In such cases, the actual amount of metal discharged may be very significant in the environment and require removal. One such example is the Konkolo Deeps mine in Zambia where the copper ion concentration in the effluent is in the order of 0.2 ppm but the flow rate is in excess of 230,000 cubic metres per day. Thus, the immobilisation or tethering reaction should be conducted in as few steps as possible, using low cost substrates and at as low a chemical cost as possible but to still produce a stable final product. Any chemical modification of the polyethyleneimine may be conducted prior to, or subsequent to, the tethering step(s) in accordance with the chemical reaction mechanisms desired to be conducted.

The present invention advantageously provides improved methods for conducting tethering reactions and provides solid products which exhibit improved metal ion complexation kinetics, particularly for the complexation with copper and displacement of cyanide from copper cyanide solutions.

### DESCRIPTION OF THE INVENTION

According to a first aspect of the invention there is provided a metal ion extractant material for use in the extraction of metal ions from a solution or slurry, the extractant material comprising:
a solid substrate; and
an ethyleneimine-containing polymer attached to the solid substrate.

According to a second aspect of the invention there is provided a particulate metal ion extractant material for use in the extraction of metal ions from a solution or slurry, the particulate extractant material comprising particles which include:
a solid substrate; and
an ethyleneimine-containing polymer attached to the solid substrate;
wherein said ethyleneimine-containing polymer has been cross-linked during or subsequent to attachment to said substrate, and the resulting material ground to form the particulate extractant material.

According to a third aspect of the invention there is provided a particulate metal ion extractant material for use in the extraction of metal ions from a solution or slurry, the particulate extractant material comprising particles of cross-linked ethyleneimine-containing polymeric material formed by cross-linking said ethyleneimine-containing polymeric material and subsequently grinding the cross-linked polymeric material.

According to a fourth aspect of the invention there is provided a process for the extraction of metal ions from a solution or slurry comprising contacting the solution or slurry with a metal ion extractant material as described in any one of the immediately preceding three paragraphs to load the extractant material with metal ions and separating the loaded extractant material from the solution or slurry.

There is also provided methods for the production of the above-mentioned metal ion extractant materials as will be appreciated from the following more detailed description of the invention.

This invention in a first aspect broadly involves the attachment of chains containing ethyleneimine (EI) groups to a solid substrate. Typically this substrate has an oxide surface. The oxide surface can be activated prior to attachment to create reactive surface groups. The polymer is either attached directly via some point along its backbone, or is attached via a linking group which thereby has the effect of spacing the polymer functional units away form the solid substrate.

According to a second aspect, it is also possible to crosslink the EI containing polymer at the same time as it is tethered to the solid substrate, preferably having an oxide surface, or subsequent to this. In this case the material formed is typically ground to an appropriate size before use.

The solid substrate may be selected from a wide variety of types. These include TiO₂ and Al₂O₃ as well as filler materials such as silica, talc, carbonates and sulphides. Porous zeolite materials may also be used. The material will typically have a particle size suitable for the application intended. A further variation on the solid substrate is to use another polymer material such as activated polystyrene beads.

Alternatively, according to a third aspect, the solid substrate can be omitted completely and crosslinked PEI material used alone after grinding to a suitable particle size.

Whilst polyurethane foams have been proposed as a substrate, the presence of the silicone cell control agent used in the manufacture of these foams has prevented a suitably stable attachment of the desired ligand to the foam surface, particularly when the tethering reaction is conducted in an aqueous environment. The cellulose sponge material used as the substrate for U.S. Pat. Nos. 4,332,916, 5,002,984, 5,064,540, 5,096,946, 5,162,404, 5,169,883, 5,187,200, 5,294,652, 5,336,704, 5,595,652 and 5,597,850 exhibits very poor tear strength. This limits the applications for the resultant product. The polyurea-urethane-based sponge materials the subject of U.S. Pat. Nos. 3,793,241; 3,854,535; 3,861,993; 3,890,254; 3,900,030; 3,903,232, 3,904,557; 4,110,508; 4,127,516; 4,137,200; 4,158,087; 4,160,076; 4,181,770; 4,266,043; 4,292,412; 4,314,034; 4,365,025; 4,337,645; 4,384,050; 4,384,051; 4,638,017; 4,717,738; 4,725,628; 4,731,391; 4,740,528; 4,789,720; 4,798,876; 4,828,542; 5,065,752; 5,296,518; 5,591,779 and 5,624,971 which are incorporated herein by reference exhibit high tear strength and do not contain silicone surfactants. Their cell control is achieved by the use of water soluble poly(ethylene-propylene oxide)-based surfactants. It has been discovered that these polymers also provide an excellent substrate for tethering the polyethyleneimine-based polymers. Reference is also made to U.S. Pat. Nos. 4,332,916, 5,002,984, 5,064,540, 5,096,946, 5,162,404, 5,169,883, 5,187,200, 5,294,652, 5,336,704, 5,595,652 and 5,597,850 which are incorporated herein by reference.

Polyethyleneimine or a derivative thereof is tethered to a solid substrate such as TiO₂ or Al₂O₃ via a condensation reaction. To promote this reaction the surface of the solid is activated by treatment at 420° C. for 15 minutes prior to contacting the polymer. The polymer is preferably derivatized to produce a limited number of primary alcohol or carboxylic acid groups (or derivatives thereof). The linking reaction takes place via these alcoholic or acidic groups. The derivitization of the polyethyleneimine can be achieved by reaction of the polymer with an hydroxyalkyl halide to form a tertiary nitrogen of the structure:
>N—(CH₂)ₓOH
where x is typically between 2 and 6.

The extent of such derivitization is typically between 1 and 50% of the nitrogen atoms in the polymer and preferably between 1 and 10% of the nitrogens. An alternate linking group can be obtained by oxidizing this alcoholic functionality to its corresponding carboxylic acid using standard methods. The resultant group is then of structure:
>N—(CH₂)ₓ—COOH
where x is as described above. An alternate method of linking to an activated oxide surface involves the use of a diisocyante. A molar amount of diisocyante corresponding to between 1 and 50 mol % of polymer N—H units is used. Preferably between 1 and 10% diisocyante is used. The diisocyante is reacted by mixing with the activated oxide materials and heating to create an adduct between the oxide and the diisocyante. The polymer is then added and the mixture further heated. A catalyst is used chosen from the many available for the production of polyurethanes.

A variation on this process involves using a larger amount of di-isocyanate and mixing all of the components together in the same vessel with stirring during the initial stages of reaction. This has the effect of creating a solid cross-linked mass of elastomeric material. The crosslinked material is nonetheless tethered to the oxide material via the urethane links. This mass is then milled using for example cryogenic grinding techniques to a suitable particle size.

A yet further alternative methods of tethering or crosslinking and tethering include the formation of polyamide links to the polyethyleneimine by use of a dicarboxylic acid. Typically this acid will have structure:
HOOC—R—COOH
where R can be an alkyl chain —(CH₂)ₓ— where x is up to 12 carbons in length, for example adipic acid, or can be a cyclo-aliphatic or aromatic structure, in the latter case for example phthalic acid. Anhydrides and diacyl chlorides are equally useful starting materials for this type of tethering; hexan-dioylchloride is particularly useful in this regard. The polyamide formation involving these reagents is carried out by well known methods familiar to those experienced in the art of polymer chemistry. In the case where only a tethering reaction is desired, the reagents is first reacted with the activated oxide filler material by mixing and heating to remove the water produced. This product is then mixed with the polyethylimine and further heated to complete the reaction. The total content of the linking reagent is typically between 1 and 50 mol % of polymer N—H units is used. Preferably between 1 and 10% of the linking reagent is used.

If a crosslinked and tethered formulation is required, the procedure is as described previously using a larger quantity of the linking reagent.

If a longer alkyl chain —(CH₂)ₙ— is present, that is where x is significantly greater than 12 carbons in length, for example stearic acid, then water insolubility can be achieved. Such a water insoluble polymer can be solubilized using a suitable organic solvent enabling the EI-based polymer to be coated onto the surface of a suitable material. It may also be dissolved in a monomer such as styrene, enabling it to be incorporated into a polyurethane, acrylic or styrene-based resin matrix as previously described.

A still further method of tethering or crosslinking with tethering involves the use of hydroxyethylated PEI. With this polymer it is possible to form ester type linking groups with the oxide surface using the dicarboxylic acid or the various derivatives described above.

Further derivitization of the PEI allows the use of more selective tethering reactions or more control over the frequency of the tethering reactions. For example, if the hydroxyethylated PEI is partially oxidized such that around 1-10%, preferably between 1 and 2% of the CH₂—OH units are oxidized to COOH units, then these units can either be directly tethered to the activated oxide surface or they can be tethered via the use of a diol or diamine reagent.

A quite different approach to crosslinking PEI involves the derivitization of the polymer with a group containing a vinyl or acrylic moiety. Such groups can then be polymerized using traditional methods. For example, a chloromethylated polystyrene-divinyl benzene resin may be reacted with polyethyleneimine to produce a copper- and cobalt-selective ion exchange resin.

One advantage displayed by controlling both the length of the linker to the substrate and the molecular weight of the polyethyleneimine is shown by the improved selectivity for particular metal ions and importantly, the improved kinetics in the rate of extraction of metal ions from solution. In this regard, where a linker is used, the length thereof is advantageously selected taking into consideration the anticipated final use of the extractant material.

Furthermore, solid polymers have been produced which are capable of selectively recovering copper and displacing the cyanide ions from copper cyanide-containing solutions and not recovering gold cyanide also present in the same aqueous solution. The gold cyanide can be separately recovered using activated carbon. This presents a method by which copper and gold can be selectively recovered from aqueous solutions and importantly, from slurries.

In certain metal ion extraction processes a valency change may occur, as for example in the selective displacement of copper(II) ions from copper(I) cyanide. To achieve this oxidation change an oxidant such as oxygen may beneficially assist the displacement reaction. Thus, there may be the need to introduce air or oxygen into such a process to assist in this displacement reaction.

Particular embodiments of the invention will now be described with reference to the following examples which are provided for exemplification only and which should not be construed as limiting on the invention in any way.

### EXAMPLE 1

A chloromethylated polystyrene divinyl benzene resin manufactured by Ion Exchange (India) Limited was reacted with polyethyleneimine which was manufactured by BASF A.G. and having an average MW of 1800. 3 mL of this resin was contacted for 24 hours with 100 mL of a synthetic acid mine drainage solution containing copper, cobalt, iron and aluminium. Some 69.1% of the copper and 33.3% of the cobalt was extracted.

### EXAMPLE 2

A resin similar to Example 1, but in which the polyethyleneimine was attached to the polystyrene-divinyl benzene by an alkyl chain of 6 carbons in length. Under the conditions enunciated above, the copper capacity was 0.9 mmol/g.

### EXAMPLE 3

The ion exchange resin described in Example 1 was reacted with carbon bisulphide to form a dithiocarbamate functional group. This resin was contacted with a synthetic copper, cobalt, iron and aluminium acid mine drainage solution. After contacting the resin with the solution for 24 hours, >99% of the copper and of the cobalt were removed from the solution.

### EXAMPLE 4

A silicone-free hydrophilic polyurethane sponge material as described in Australian Patent Application No. 87067/98 was imbibed into an aqueous solution containing various mixtures of nitrilotriacetic acid polyethyleneimine and then cured. The resultant polymer was then contacted with an acidic solution of copper sulphate for 24 hours. The polymer removed 1.6 mmol/g of dry resin. The polymer remained stable and fixed to the polyurethane sponge material. The use of a conventional polyurethane foam was reported by Rainer in Example 5 of his U.S. Pat. No. 5,096,946 to be unstable. The stability achieved in this Example is likely to be due to the different surface chemistry and hydrophilicity obtained by the use of the sponge material described in Australian Patent Application No. 87067/98.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that that prior art forms part of the common general knowledge in Australia.

Those skilled in the art will appreciate that the invention described herein is susceptible to variations and modifications other than those specifically described. It is to be understood that the invention includes all such variations and modifications which fall within its spirit and scope. The invention also includes all the steps, features, compositions and compounds referred to or indicated in this specification, individually or collectively, and any and all combinations of any two or more of said steps or features.

1. A metal ion extractant material for use in the extraction of metal ions from a solution or slurry, the extractant material comprising:
a solid substrate; and
an ethyleneimine-containing polymer attached to the solid substrate.

2. A particulate metal ion extractant material for use in the extraction of metal ions from a solution or slurry, the particulate extractant material comprising particles which include:
a solid substrate; and
an ethyleneimine-containing polymer attached to the solid substrate;
wherein said ethyleneimine-containing polymer has been cross-linked during or subsequent to attachment to said substrate, and the resulting material ground to form the particulate extractant material.

3. An extractant material according to claim 1 or 2, wherein the solid substrate has an oxide surface which is optionally activated prior to attachment of the ethyleneimine-containing polymer.

4. An extractant material according to claim 1 or 2, wherein the solid substrate is selected from the group consisting of TiO₂, Al₂O₃, filler materials such as silica, talc, carbonates and sulfides, porous zeolite materials and polymeric materials such as activated polystyrene beads and silicone-free polyurethane foam.

5. A particulate metal ion extractant material for use in the extraction of metal ions from a solution or slurry, the particulate extractant material comprising particles of cross-linked ethyleneimine-containing polymeric material formed by cross-linking said ethyleneimine-containing polymeric material and subsequently grinding the cross-linked polymeric material.

6. A process for the extraction of metal ions from a solution or slurry comprising contacting the solution or slurry with a metal ion extractant material according to claim 1, 2 or 5 to load the extractant material with metal ions and separating the loaded extractant material from the solution or slurry.

7. A process according to claim 6, wherein the metal ions include copper ions.
